(19) United States
(12) Patent Application Publication
(10) Pub. No.: US 2013/0008803 A1
(43) Pub. Date: Jan. 10, 2013

(54) Methods and Systems for Measurement of Tear Glucose Levels

(75) Inventors: Mark E. Meyerhoff, Ann Arbor, MI (US); Bruce E. Cohan, Ann Arbor, MI (US); Qinyi Yan, Davie, FL (US); Bo Peng, Ann Arbor, MI (US); Zvi Flanders, Ann Arbor, MI (US)

(73) Assignees: THE REGENTS OF THE UNIVERSITY OF MICHIGAN, Ann Arbor, MI (US); EYELAB GROUP, LLC, Ann Arbor, MI (US)

(21) Appl. No.: 13/342,634

(22) Filed: Jan. 3, 2012

Related U.S. Application Data
(60) Provisional application No. 61/429,291, filed on Jan. 3, 2011.
(60) Provisional application No. 61/498,757, filed on Jun. 20, 2011.

(51) Int. Cl. G01N 27/327

(52) U.S. Cl. 205/777.5; 204/403.14

(57) ABSTRACT

A sensor system for determining glucose concentration in a tear fluid sample includes a working electrode including an immobilized glucose oxidase enzyme portion for reacting with glucose in the tear fluid sample, and a selectivity portion for enhancing the selectivity for glucose over electroactive interferent species in the tear fluid sample. Alternatively, a vessel for receiving the tear fluid sample may include the enzyme portion on an inner wall thereof. A reference electrode is disposed adjacent the working electrode, wherein the electrochemical reaction of the enzyme portion with glucose in the tear fluid sample generates a current related to the glucose concentration in the tear fluid sample.

### CROSS-REFERENCE TO RELATED APPLICATIONS

This application claims the benefit of U.S. provisional Application No. 61/429,291 filed Jan. 3, 2011 and U.S. provisional Application No. 61/498,757, filed Jun. 20, 2011, the disclosures of which are incorporated in their entirety by reference herein.

### TECHNICAL FIELD

Embodiments relate to methods and systems for amperometric and coulometric measurement of tear glucose concentration with a glucose sensor configuration.

### BACKGROUND

Glucose monitoring technologies have drawn significant attention over the past several decades to help in the management of diabetes, which afflicts about 5% of the world's population. Tight glycemic control is critical to the care of patients with diabetes as well as to prevent complications such as cardiovascular disease. It is recommended that blood glucose levels be measured several times a day, which usually requires finger pricking coupled with measurement using a strip-test type glucometer (with either optical or electrochemical readout). However, in practice, patients may not follow these recommendations, and this might be largely due to the accumulated pain/discomfort from the repeated finger pricks and blood collection.

A number of studies have been carried out to find a less invasive means to monitor blood glucose levels, including the use of infrared spectroscopy (Maruo K et al., Appl. Spectrosc., 2006, 60(12), 1423-1431; Mueller M et al., Sensor. Actuat. B-Chem., 2009, 142(2), 502-508), a GlucoWatch design that is based on electro-osmotic flow of subcutaneous fluid to surface of skin (Potts R O et al., Diabetes-Metab. Res., 2002, 18, S49-S53), and measurement of tissue metabolic heat conformation (Cho O K et al., Clin. Chem., 2004, 50(10), 1894-1898), but none of these techniques have yet yielded the quality of analytical results required to become a full substitute for blood glucose measurements.

### BRIEF DESCRIPTION OF THE DRAWINGS

FIG. 1 illustrates an amperometric sensor configuration for measurement of tear glucose concentration according to an embodiment;

FIGS. 2a-b are graphs depicting the calibration of a tear glucose sensor according to FIG. 1 using 5 μL solution in capillary, showing solutions in the order of 100 μM ascorbic acid, 100 μM uric acid, 10 μM acetaminophen, 100 μM, 500 μM and 1000 μM glucose solution, and showing the calibration curve of the tear glucose sensor, respectively;

FIGS. 3a-e are graphs depicting the correlation between tear and blood glucose levels using a rabbit model with a tear glucose sensor according to FIG. 1, wherein FIGS. 3a-b shows the results from two individual rabbit experiments, FIG. 3c shows all the data points of tear and blood glucose values of the total 12 rabbits, FIG. 3d shows the average values of both tear and blood glucose levels for all animals in the study at every half hour time point, and FIG. 3e is a 2^{nd} order polynomial correlation between average tear and blood glucose levels;

FIG. 4 illustrates a coulometric sensor configuration for measurement of tear glucose concentration according to another embodiment;

FIG. 5 is a graph illustrating the coulometric response of a tear glucose sensor according to FIG. 4 to different glucose concentrations at 50° C.;

FIG. 6 is a graph illustrating a calibration curve of a tear glucose sensor according to FIG. 4 at varying detection durations; and

FIG. 7 illustrates an alternative coulometric sensor configuration for measurement of tear glucose concentration according to another embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The approach of testing glucose in tear fluid as a substitute for blood provides a unique possibility of developing a relatively simple non-invasive method of detecting glucose concentration, if it can be clearly shown that tear glucose levels correlate closely with blood glucose values. If a good correlation between the two types of samples can be established, measurement of tear glucose levels could provide an attractive indirect measurement method for blood glucose levels within the normal as well as hyperglycemic and hypoglycemic ranges. For such a method to be effective, tear fluid needs to be collected using a non-stimulating method so that increases in tear production do not further dilute out the naturally present glucose levels. At the same time, it is important to sample the tear fluid without inflicting any damage to blood capillaries within the eye, which might result in tear samples with much higher levels of glucose than actually present in the neat tear fluid sample.

The requirements of tear glucose detection include a low detection limit (i.e., μM range), high selectivity over interferences such as ascorbic acid and uric acid, and the ability to measure small sample volumes as tear fluid can only be collected via a few microliters at a time. Published methods include capillary electrophoresis (CE) coupled with laser-induced fluorescence (LIF) (Jin Z et al., Anal. Chem., 1997, 69(7), 1326-1331), fluorescence sensors (Badugu R et al., Talanta, 2005, 65(3), 762-768), liquid chromatography (LC) coupled with electrospray ionization mass spectrometry (ESI-MS) (Baca J T et al. Clin. Chem., 2007, 53(7), 1370-1372), holographic glucose sensor (Yang X P et al., Biosens. Bioelectron., 2008, 23(6), 899-905), miniaturized flexible thick-film flow-cell detector (Kagie A et al., Electroanal., 2008, 20(14), 1610-1614), and a strip-type flexible biosensor (Chu M X et al., Biomed. Microdevices, 2009, 11(4), 837-842). Badugu et al. (Badugu R et al., Journal of Fluorescence, 2004, 14(5), 617-633; Badugu R et al., Current Opinion in Biotechnology, 2005, 16(1), 100-107) also reviewed the feasibility of using disposable contact lenses to monitor glucose through ophthalmic detection. An apparatus and method for determining tear glucose concentration were also described in U.S. Pat. No. 7,133,712 to Cohan et al. and U.S. Application Publication No. 2007/0043283 to Cohan et al., both incorporated by reference herein.

Using an enzymatic method, it was found that tear glucose levels were significantly higher in diabetic patients with higher blood glucose levels than normal patients (Sen D K and Sarin G S, Br. J. Ophthalmol., 1980, 64(9), 693-695). However, levels of glucose in tears have been found to be typically 30-50 times lower than in blood. Baca et al. recently reviewed studies of the correlation between blood and tear glucose levels using different detection methods (Baca J T et al., Ocul. Surf., 2007, 5(4), 280-293), and concluded that there is evidence of a correlation between average tear and blood glucose concentrations, but further characterization and justification is needed from animal and human studies to determine the potential utility of tear glucose measurement to help achieve glycemic control.

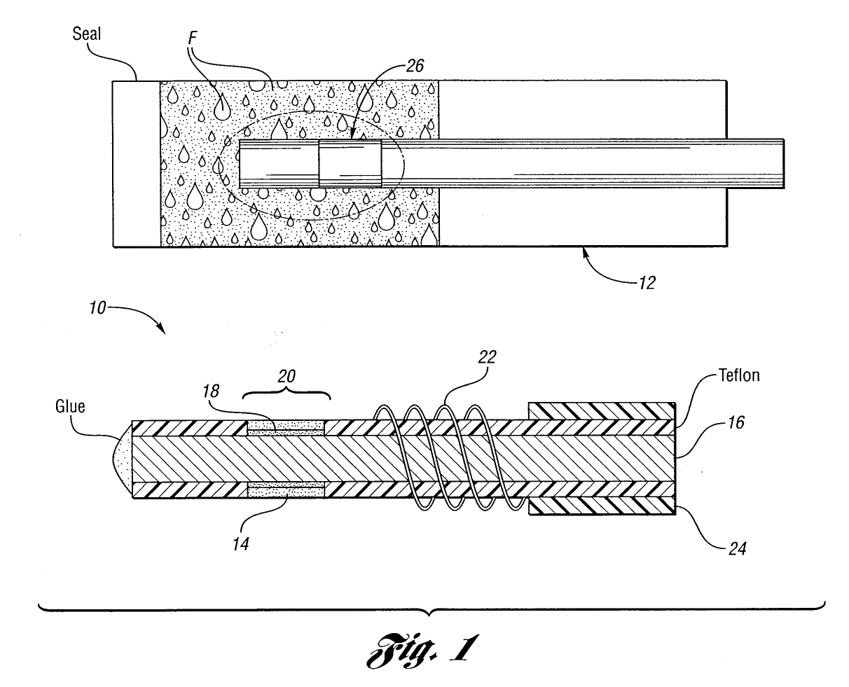

Electrochemical systems and methods are described herein for quantitating glucose levels in micro-liter volumes of tear fluid. According to an embodiment illustrated in FIG. 1, an amperometric electrochemical glucose sensor 10 intended for tear glucose measurements is described and employed in conjunction with a vessel such as a capillary tube 12 (for example, but not limited to, 0.84 mm i.d.) to receive microliter volumes of tear fluid F. The sensor 10 is constructed by immobilizing glucose oxidase enzyme 14 on a platinum/iridium (Pt/Ir) wire 16 (for example, but not limited to, 0.25 mm o.d.) and anodically detects the liberated hydrogen peroxide from the enzymatic reaction. A selectivity portion 18 which may comprise layers of NAFION® cation exchange polymer and an electropolymerized film of 1,3-diaminobenzene/resorcinol greatly enhance the selectivity for glucose over potential known electroactive interferent species in tear fluid, including ascorbic acid and uric acid. In some cases, the ratio of these interferent species to the glucose level in tear fluid is much greater than in blood, necessitating that the inner layers 18 be even more effective in rejecting these interference species than in similar sensors designed for blood glucose measurements.

Further, unlike sensors for measurement of glucose in blood, the sensor 10 described herein is optimized to achieve the very low detection limits for glucose (e.g., <10 μM) required to accurately monitor the reported glucose concentrations in tear fluid. In one embodiment, the sensor 10 is optimized to achieve a detection limit of 1.5±0.4 μM of glucose (S/N=3) that is required to monitor glucose levels in tear fluid with a glucose sensitivity of 0.022±0.007 nA/μM (n=4). With this sensor configuration, in one embodiment only about 3 μL or less of tear fluid in the capillary tube 12 is required in order to measure the glucose when the sensor 10 is inserted into the capillary 12, although even smaller diameter sensor designs are contemplated to enable measurements with even less volume. Herein, according to an embodiment, an amperometric sensor 10 for glucose is described that is capable of measuring the levels of glucose in tear fluid F down to 1.5 μM, within a capillary tube 12 containing about 3 μL or less of tear fluid F.

FIG. 1 illustrates an amperometric sensor 10 used for tear glucose measurement according to one embodiment. The tear glucose sensors described herein reference configurations used to prepare electrochemical sensors suitable for subcutaneous measurements of glucose (Bindra D S et al., Anal. Chem., 1991, 63(17), 1692-1696; Gifford R et al., J. Biomed. Mater. Res. A, 2005, 75A(4), 755-766). Glucose oxidase (Type VII, From Aspergillus niger), d-(+)-glucose, glutaraldehyde, bovine serum albumin (BSA), sodium chloride (NaCl), potassium chloride (KCl), sodium phosphate dibasic (Na₂HPO₄), potassium phosphate monobasic (KH₂PO₄), iron (III) chloride (FeCl₃), 37% hydrochloric acid (HCl), L-ascorbic acid, uric acid, NAFION®, 1,3-diaminobenzene, and resorcinol, were all purchased from Sigma-Aldrich (St. Louis, Mo.). Platinum/iridium (Pt/Ir) and silver (Ag) wires were products of A-M Systems (Sequim, Wash.).

In one embodiment, a working electrode may be constructed from a 10 cm long TEFLON®-coated Pt/Ir wire 16 of 0.2 mm outer diameter which is cut and a 1 mm cavity 20 created (by stripping the TEFLON®) at 4 mm upstream from one end. Starting at about 1.5 mm upstream from the cavity 20, a 15 cm, a reference electrode which may comprise a 0.1 mm o.d. silver/silver chloride (Ag/AgCl) wire 22 is tightly wrapped around the TEFLON®-coated Pt/Ir wire 16 and covering a length of about 4 mm. The Ag/AgCl wire 22 may be prepared by dipping the Ag wire into FeCl₃/HCl solution. The straight section upstream from the wrapped Ag/AgCl wire 22 may be covered with a 5 cm long, 0.4 mm o.d., heat shrink polyester tubing 24 (Advanced Polymers, Salem, N.H.). It is understood that the above dimensions are not intended to be limiting, and other dimensions of the components described above may alternatively be employed.

A selectivity portion comprising inner polymeric layers 18 deposited on the Pt/Ir working electrode 16 may be used to eliminate interferences from ascorbic acid, uric acid, and acetaminophen, for example. In one embodiment, the cavity 20 is coated with a thin layer of NAFION® (for example, but not limited to, ca. 5 μm thick). Then, electropolymerization of a solution containing 1.5 mM 1,3-diaminobenzene and a similar concentration of resorcinol in PBS buffer (0.1 M, pH 7.4) is initiated using a Voltammograph potentiostat (Bioanalytical Systems Inc., West Lafayette, Ind.) with a cycling voltage of 0 to +830 mV at a scan rate of 2 mV/s for 18 h (Geise R J et al., Biosens. Bioelectron., 1991, 6(2), 151-160). An enzyme portion 14 may be created by first dropping 1 μL of a 3% (wt %) glucose oxidase solution containing also 3 wt % BSA in the cavity 20 along the wire 16 and drying this layer for 30 min. Then the enzyme was crosslinked by adding 1 μl of 2% (vol/vol) glutaraldehyde solution and curing in air for 1 h. The sensor 10 may then be rinsed with deionized water and stored in 0.1 M PBS (pH 7.4) buffer for future use. It is understood that the above concentrations, solutions, and times are not intended to be limiting, and that modifications to these protocols and application to other sensors described herein are contemplated.

The low detection limit achieved by the sensor 10 described herein may be achieved by not coating the outer surface of the sensor 10 with an additional membrane that restricts diffusion of glucose to the enzymatic layer 14. Such an additional coating is required for blood and subcutaneous glucose sensing in order to ensure that oxygen is always present in excess compared to glucose in the enzymatic layer to achieve linear response to high glucose concentrations. However, given the much lower levels of glucose in tear fluid, no outer membrane is needed to retard glucose diffusion, since oxygen levels will be always in excess in such samples. This ultimately enables the very low detection limit of the sensor 10.

According to one embodiment, to measure glucose in tears, the sensor 10 is first calibrated (recording steady-state currents) with 2-3 levels of glucose. Then, tear fluid F is sampled using a capillary tube 12. The calibrated sensor 10 is then inserted into the capillary tube 12 so that the tear fluid F completely covers the sensing region 26 with the immobilized enzyme 14. A voltage is applied to the electrodes 16, 22 to induce an electrochemical reaction of the enzyme 14 and glucose in the tear fluid sample, and a resulting steady-state current is generated that is proportional to glucose concentration in the tear fluid sample.

More particularly, the amperometric tear glucose sensor 10 may be calibrated on a 4-channel BioStat potentiostat (ESA Biosciences Inc., Chelmsford, Mass.). The sensor 10 is first polarized at a potential of +600 mV vs. Ag/AgCl reference electrode in a vial containing 10 mL of PBS buffer solution. Five microliters of glucose standard solutions (100, 500 and 1000 μM) prepared in PBS were collected by individual 0.85 mm i.d. glass capillaries (World Precision Instruments, Sarasota, Fla.) and sealed with Critoseal (McCormick Scientific, Richmond, Ill.). The sensor 10 is then taken out of the PBS, blotted briefly with Kimwipes (Kimberly-Clark, Ga.) to remove excess solution and inserted into the capillary so that the solution completely covered the sensing region 26 with the immobilized enzyme 14 (FIG. 1). After a stable current was achieved (typically within 2 min), the sensor 10 was finally rinsed with water three times and then put back into the stock PBS buffer to reach the steady-state baseline value in preparation for the next measurement within the capillary tubes 12.

To test the sensor selectivity over interferences, standard solutions containing potential interferent species at their maximum possible levels in tear fluid (Choy C K M et al., Invest. Ophthalmol. Vis. Sci., 2000, 41(11), 3293-3298; Choy C K M et al., Optom. Vis. Sci., 2003, 80(9), 632-636) (i.e., 100 μM of ascorbic acid, 100 μM of uric acid and 10 μM of acetaminophen (based on the dilution factor blood ratio) were collected in capillaries, and the response current for each interferent species was measured. Based on the sensitivity of the sensor 10 to glucose, and the amperometric signal observed for these interferent species, the % error that would occur for samples containing these levels of interferences and 100 μM tear glucose were calculated. To test the repeatability of the tear glucose sensor 10, the sensor 10 was inserted into five separate capillaries containing 5 μL of 100 μM glucose, with washing and stabilizing the baseline in PBS buffer in between these multiple measurements. The average reported glucose concentration was determined from a prior calibration curve made in capillary tubes using 100, 500, and 1000 μM glucose standards.

The sensor 10 was further utilized to assess the correlation between tear glucose levels and blood glucose concentrations. Twelve white rabbits (Myrtle's Rabbitry, Thompson's Station, Tenn.) were used in this study to test the correlation between tear glucose measured with the amperometric sensor 10 and blood glucose levels. An anesthesia protocol (Major T C et al., Biomaterials, 2010, 31(10), 2736-2745) was followed for the experiments with the exception that the maintenance fluid rate was adjusted to 3.3 mL/kg/min. All rabbits were under anesthesia for 8 h. The tear glucose sensor 10 was polarized at +600 mV in PBS buffer through the duration of the entire experiment. The sensor 10 was calibrated in capillary tubes with 100 μM glucose in the middle of the 8 hour experiment. Every 30 min, 0.6 mL blood was drawn and the blood glucose level was measured using a 700 Series Radiometer blood analyzer (Radiometer America Inc., Westlake, Ohio) that employs a macro-electrochemical enzyme electrode to quantitate blood glucose. At the same time, 5 μL of rabbit tear fluid F was collected in the capillary 12 and the current from the glucose in the tear fluid F was recorded using the tear glucose sensor 10. The tear glucose level was calculated from the one point calibration result. Statistical data analysis was carried out to examine the correlation between the blood and tear glucose values within given animal and across all 12 animals involved in the study.

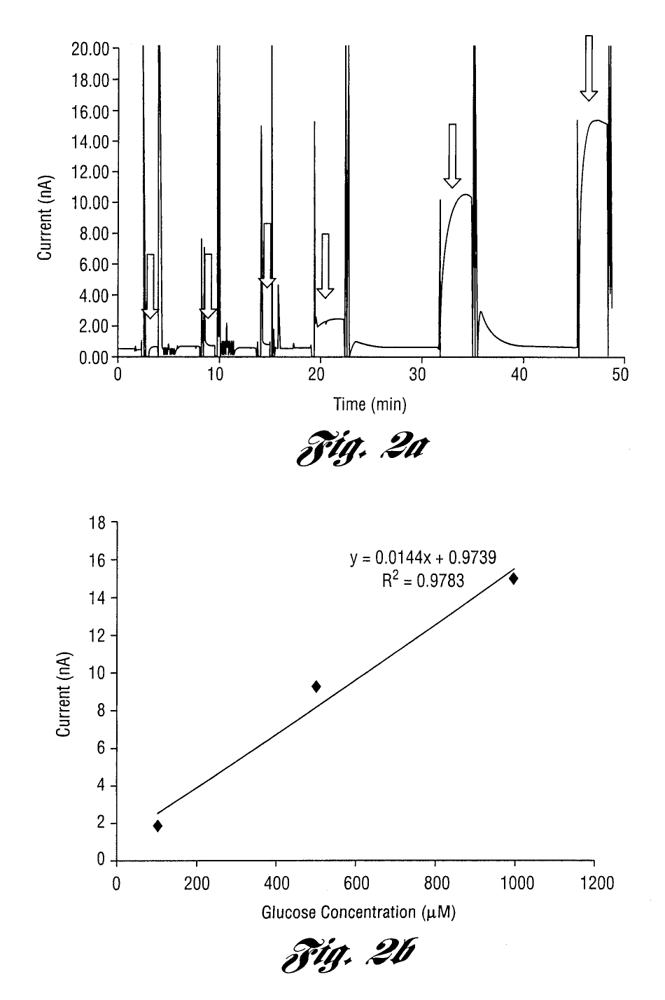

A typical calibration curve for the amperometric tear glucose sensor 10 as described herein is shown in FIG. 2. In one embodiment, the detection limit is 1.5±0.4 μM of glucose (S/N=3) and the glucose sensor 10 has an average sensitivity of 0.022±0.007 nA/μM of glucose (n=4). The linear range can reach to 1000 μM which is nearly 10-fold greater than the average normal value of 138 μM found previously for tear glucose levels in humans (Jin Z et al., Anal. Chem., 1997). From the repeatability test of the tear glucose sensors 10, they showed an acceptable repeatability with an average of 102.5±5.6 μM measured for the 5 measurements in individual capillaries containing ca. 5 μl of 100 μM glucose solution each.

Any glucose sensor designed for measurements in physiological tear fluid should exhibit acceptable selectivity over existing electroactive species typically present in tears at the potential of +600 mV vs. Ag/AgCl reference electrode used to detect the hydrogen peroxide generated from glucose oxidase reaction with glucose. It has been reported in the literature that ascorbic and uric acid concentrations in tear fluid are ca. 20 and 70 μM, respectively (Choy C K M et al., Invest. Ophthalmol. Vis. Sci., 2000; Choy C K M et al., Optom. Vis. Sci., 2003). As a result, 100 μM of both ascorbic acid and uric acid were used to test the selectivity of the tear glucose sensor 10. For small neutral molecule interferences, 10 μM of acetaminophen was employed for testing, assuming that this species would be present in tear fluid at a similar relative dilution ratio compared to blood as glucose. The error percentage was calculated by dividing the current of certain interference by that observed for a 100 μM standard of glucose. The presence of the NAFION® and electropolymerized 1,3-diaminobenzene/resorcinol inner layer 18 enabled the sensor 10 to exhibit excellent exclusion of interferences with the % errors for ascorbic acid, uric acid and acetaminophen of 6.45±4.06, 3.75±2.88 and 3.55±1.76%, respectively (n=4). These results indicate that the tear glucose sensor 10 has acceptable selectivity over major electroactive interferences found in tear fluid and that results obtained for tear samples will likely reflect the true level of glucose present in such samples.

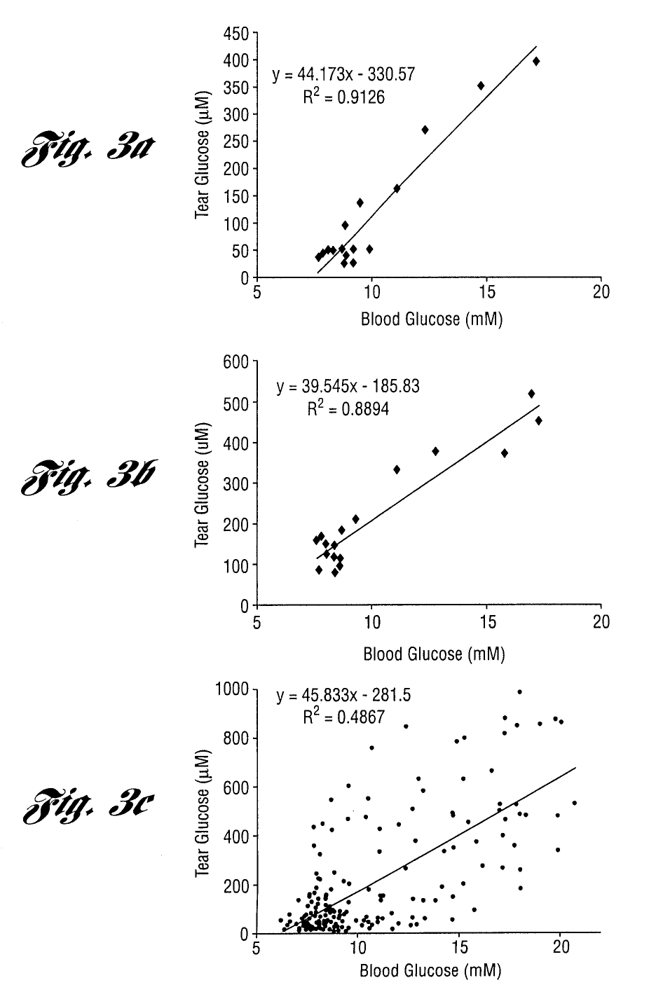

FIGS. 3a and 3b show the Pearson's correlation between tear and blood glucose from 2 individual rabbit experiments. The determined r² values are 0.9126 and 0.8894, respectively (p<<0.05), indicating significant correlation between tear and blood glucose concentrations. Both examples show excellent fitting to the linear regression model. FIG. 3c shows all the blood-tear glucose values from the twelve rabbit experiments. There seems to be a low correlation between blood and tear glucose concentrations when the data from all animals tested are used, based on the results obtained using Pearson's correlation analysis (r²=0.4867, p<<0.05). Furthermore, it is difficult to establish a simple mathematic function model, such as a linear relationship, between the tear and blood values for the entire data set. This is due to the fact that there was significant difference in the correlations for individual rabbits. This implies that even though the tear and blood glucose levels in each rabbit demonstrate a reasonable linearity in correlation, the variation among individuals tremendously undermines the general trend as a whole that resulted in a low global tear-blood glucose correlation.

It should be noted that there is a common trend of blood and tear glucose concentration decay from the beginning of the 8 h experiment for all the rabbits. As a result, average values of both blood and tear glucose values can be taken at each half-hour time point. The shared trend of glucose decay in both blood and tear glucose values indicates that the blood and tear glucose levels increase or decrease in tandem, but the ratio of the two levels differs from rabbit to rabbit. FIG. 3d shows the averages of the measured blood and tear glucose levels at thirty minute intervals for all 12 rabbits used in this study. A Pearson's correlation analysis reveals a significant relationship between tear and blood glucose concentrations (r²=0.9475, p<<0.05) and a linear regression shows excellent fitting. Using a 2^{nd} order polynomial correlation, the fitting model between tear and blood glucose levels would be even better (r²=0.9835) (FIG. 3e). Although this fitting shows a slightly higher correlation coefficient, it makes the model one order more complex, with only slight gains. As a result, in future applications, the linear model can still be used with acceptable accuracy.

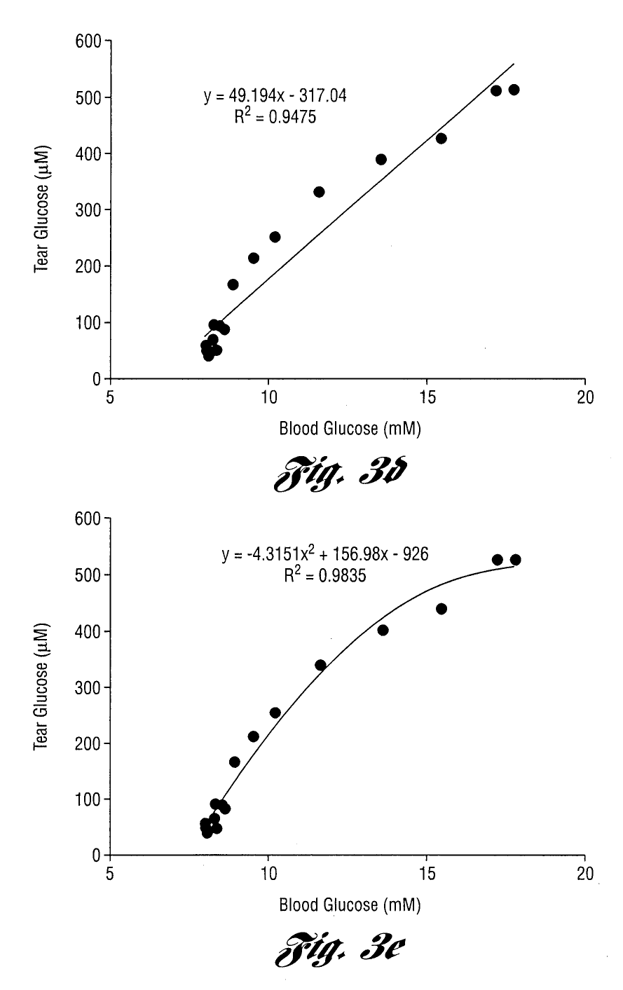

Turning now to FIG. 4, an alternative embodiment of a tear glucose sensor 110 in a coulometric configuration is depicted, wherein elements of sensor 110 similar to elements for sensor 10 described above are indicated by like reference numerals with the addition of a “1” prefix. Sensor 110 comprises an expanded size of the cavity 120 exposed and correspondingly an increased area of the immobilized glucose oxidase enzyme portion 114. Making the cavity 120 and enzyme 114 areas significantly larger and completely around the entire wire circumference that is inserted into the tear fluid sample F within the capillary tube 112 creates a situation where, in a relatively short time, most of the glucose molecules in the micro-sample of tear fluid F are consumed. Hence, the current does not reach a steady state value as in the amperometric configuration described above, but rather quickly reaches a maximum and then decreases toward a near zero value with time as the glucose in the tear fluid F is completely consumed. The analytical signal in this coulometric configuration is taken as the total number of coulombs of charge that passes through the platinum wire working electrode 116 by integrating the current as a function of time after the sensor 110 is introduced into the capillary 112. This total charge is linearly related to the concentration of glucose in the tear fluid sample F.

With the exception of the above modifications, the sensor 110 may generally be prepared as previously described for sensor 10. In one embodiment, the working electrode is constructed using a 10 cm long TEFLON®-coated Pt/Ir wire 116 of 0.2 mm outer diameter which is cut and a 1 cm cavity 120 created (by stripping the TEFLON®) at one end. Upstream from the cavity 120, a reference electrode comprising a 0.1 mm o.d. silver/silver chloride (Ag/AgCl) wire 122 is tightly wrapped around the sensor covering a length of 5 mm. The Ag/AgCl wire 122 is prepared by dipping the Ag wire into FeCl₃/HCl solution. The straight section upstream from the wrapped Ag/AgCl wire 122 may be covered with a 0.4 mm o.d., heat shrink polyester tubing 124 (Advanced Polymers, Salem, N.H.). It is understood that the above dimensions are not intended to be limiting, and other dimensions of the components described above may alternatively be employed.

As with sensor 10, a selectivity portion comprising inner polymeric layers 118 may be deposited on the Pt working electrode 116 of sensor 110 to eliminate interferences from ascorbic acid, uric acid, and acetaminophen, for example. In one embodiment, the cavity 120 is coated with three layers of NAFION® (for example, but not limited to, ca. 5 μm thick). Then, electropolymerization of a solution containing 1.5 mM, 1,3-phenoylenediamine and a similar concentration of resorcinol in PBS buffer (0.1 M, pH 7.4) is initiated using a Voltammograph potentiostat (Bioanalytical Systems Inc., West Lafayette, Ind.) with a cycling voltage of 0 to +830 mV at a scan rate of 2 mV/s for about 22-24 h (Geise R J et al., Biosens. Bioelectron., 1991, 6(2), 151-160). The enzyme layer 114 may be created by first dropping 1 μL of a 3% (wt %) glucose oxidase solution containing also 3 wt % BSA in the cavity 120 along the wire 116 and drying this layer for 30 min. Then the enzyme is crosslinked by adding 1 μl of 2% (vol/vol) glutaraldehyde solution and curing in air for 1 h. In one embodiment, 10 layers of glucose oxidase and 5 layers of glutaraldehyde may be used. It is understood that the above concentrations, solutions, and times are not intended to be limiting, and that modifications to these protocols and application to other sensors described herein are contemplated.

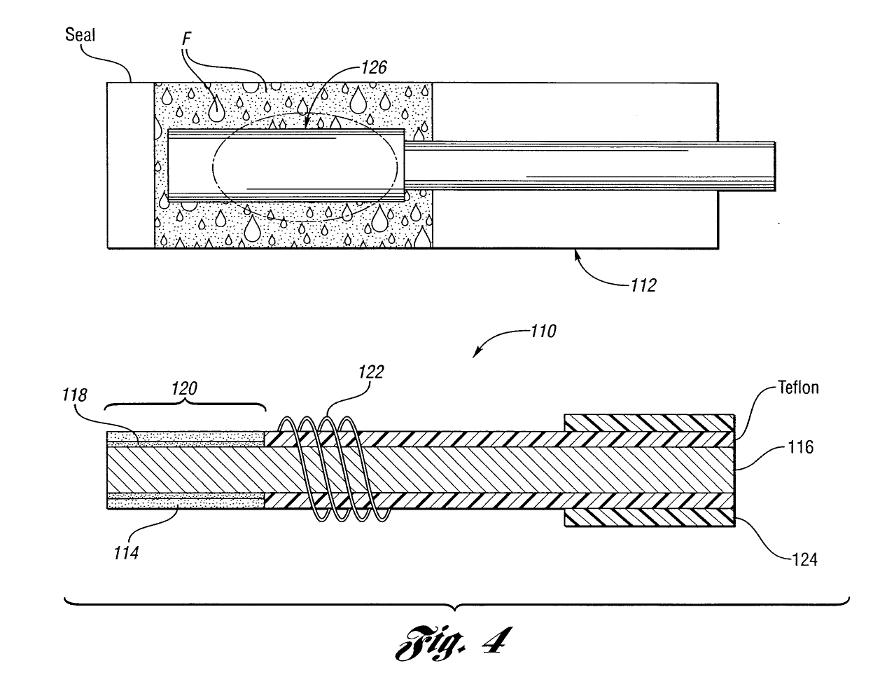

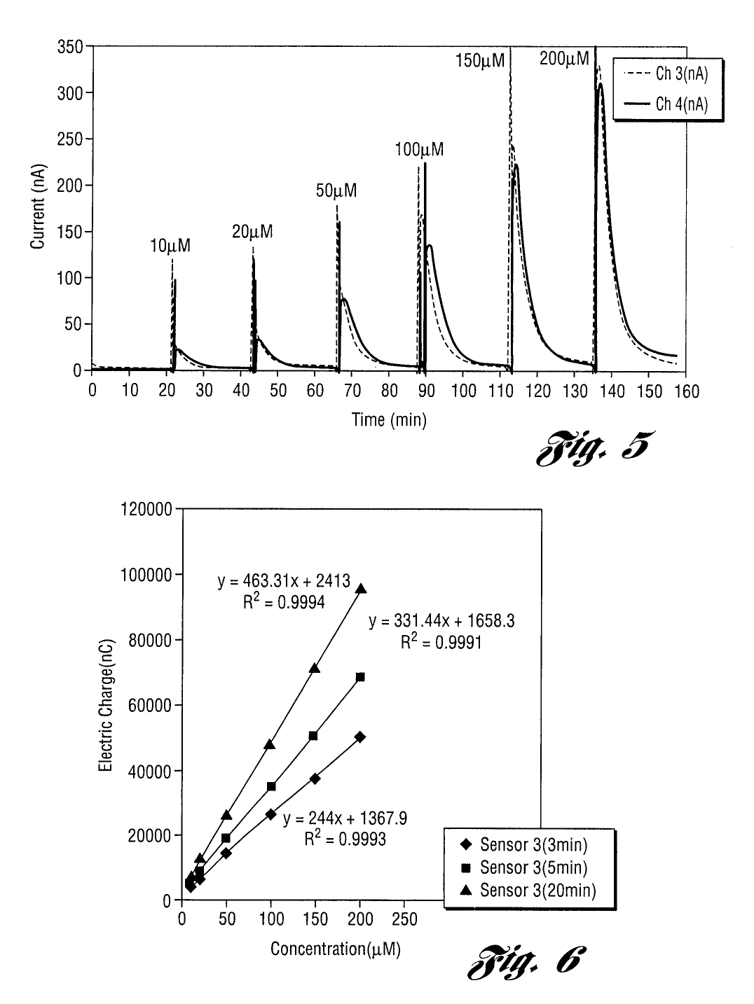

FIG. 5 is a graph illustrating the coulometric response of tear glucose sensor 110 to different glucose concentrations at 50° C., and FIG. 6 is a graph illustrating a calibration curve of tear glucose sensor 110 at varying detection durations. As shown, sensor 110 has a wide dynamic range from at least about 5 μM to 200 μM, and only about 3 μL or less of tear fluid is required.

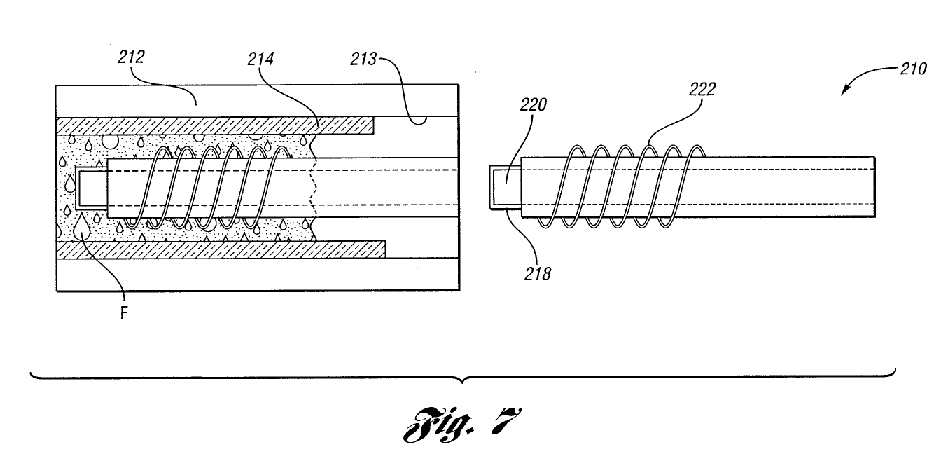

In another alternative embodiment of a tear glucose sensor, illustrated in FIG. 7 and designated generally by reference numeral 210, the enzyme is not immobilized on the sensor 210, but instead on the inner walls 213 of a vessel, such as capillary tube 212. Other elements of sensor 210 similar to elements for sensor 10 and/or sensor 110 described above are indicated by like reference numerals with the addition of a “2” prefix. A micro platinum electrode 216 detects hydrogen peroxide produced from the entire tear glucose sample F (e.g., about 3 μL or less) via the enzyme glucose oxidase 214 that is immobilized on the inner wall 213 of the sampling capillary 212. The glucose reacts to produce hydrogen peroxide that is measured electrochemically by the sensor 210. In this embodiment, the sensor 210 itself does not utilize an enzyme layer, but may include a selectivity portion comprising a polymer film coating 218 to enhance selectivity over ascorbate, uric acid, and other interferents. This configuration may allow for a reduction in the diameter of the platinum electrode 116 and cavity 220 and thus the diameter of the capillary 212, leading to a reduced volume of tear fluid F required for the measurement. As in the sensor 110 configuration described above, a coulometric measurement of total charge provides the analytical signal that is proportional to glucose levels when employing the configuration of sensor 210 in which the enzyme 214 is immobilized on the inner walls 213 of the capillary 212.

For the coulometric sensor configurations 110, 210 described above, by increasing the temperature, the diffusion of glucose to the sensor 110 or inner wall 213 of the capillary, and hydrogen peroxide molecules produced from the reaction between glucose oxidase and tear glucose (when the enzyme is on the inner wall of the capillary) will occur much faster. Therefore, the consumption of all the glucose in the tear fluid sample F will occur more quickly at higher temperatures, significantly shortening the overall glucose depletion time in the entire sample during these coulometric measurements. Currently, a 3 min. detection time can be achieved for 3 μL samples at 45 degrees C. in the capillary tube 112 using the sensor 110 configuration described above. Given that the enzyme can operate at even higher temperatures, an even shorter detection time within 1-2 minutes is envisioned for these coulometric measurement methods.

In the potential real-world application of the tear glucose sensors described herein for monitoring diabetic patients, after the correlation between tear and blood glucose levels for each individual is established (presuming, like rabbits, the exact correlation and dilution factor from patient to patient may vary), an abnormal tear glucose concentration range can be set up to detect dangerous blood glucose levels from the correlation. Thus, tear glucose levels can be measured multiple times per day to monitor blood glucose level change without the potential pain from repeated invasive blood drawing method. Indeed, blood glucose levels can still be measured using the traditional blood collection method to verify tear readings in order to trigger proper therapy when tear glucose detection suggests that blood glucose levels are out of the normal range.

Therefore, according to embodiments, an electrochemical tear glucose sensor coupled with a tear fluid collection capillary configuration has been used to monitor glucose levels in tears. The sensors exhibit excellent selectivity over known electroactive interferences, a low detection limit, a wide dynamic range, excellent repeatability and in one embodiment require only a 3 microliter or less sample volume. With further miniaturization of the sensor diameter, measurements in as little as 1-2 μL of fluid may be possible. The correlation between tear and blood glucose levels has been established in a rabbit model and data analysis suggests that a significant correlation between tear and blood glucose levels does exist, but that the exact correlation varies from animal to animal. Hence, use of tears as an alternate sample to assess blood glucose in human subjects may require that the ratio of glucose in tears and blood be established first for a given individual, so that the appropriate algorithm can be employed to report values that more closely reflect the true blood levels present.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A sensor for determining glucose concentration in a tear fluid sample, comprising:
a working electrode including an immobilized glucose oxidase enzyme portion for reacting with glucose in the tear fluid sample, and a selectivity portion for enhancing the selectivity for glucose over electroactive interferent species in the tear fluid sample; and
a reference electrode disposed adjacent the working electrode;
wherein the electrochemical reaction of the enzyme portion with glucose in the tear fluid sample generates a current related to the glucose concentration in the tear fluid sample.

2. The sensor of claim 1, wherein the working electrode comprises a Pt/Ir wire.

3. The sensor of claim 1, wherein the reference electrode comprises an Ag/AgCl wire wrapped around the working electrode.

4. The sensor of claim 1, wherein the selectivity portion is disposed beneath the enzyme portion.

5. The sensor of claim 1, wherein the enzyme portion and the selectivity portion are disposed in a cavity in the working electrode spaced upstream from an end thereof.

6. The sensor of claim 1, wherein the enzyme portion and the selectivity portion are disposed in a cavity in the working electrode disposed at an end thereof.

7. The sensor of claim 1, wherein the selectivity portion comprises coatings including NAFION® cation exchange polymer and an electropolymerized film of 1,3-diaminobenzene and resorcinol.

8. The sensor of claim 1, wherein the working electrode is not provided with any membrane to restrict diffusion of glucose to the enzyme portion.

9. The sensor of claim 1, wherein the sensor is amperometric such that a steady-state current is generated that is proportional to the concentration of glucose in the tear fluid sample.

10. The sensor of claim 1, wherein the sensor is coulometric such that a total charge generated is proportional to the concentration of glucose in the tear fluid sample.

11. The sensor of claim 10, wherein consumption of glucose in the tear fluid sample is temperature-dependent, such that a time required for total charge detection is decreased with increased temperature.

12. The sensor of claim 1, wherein the sensor is capable of achieving a detection limit of about 1.5 μM of glucose in the tear fluid sample.

13. The sensor of claim 1, wherein a volume of the tear fluid sample required is about 3 μL or less.

14. A system for determining glucose concentration in a tear fluid sample, comprising:
a vessel for receiving the tear fluid sample, the vessel including an immobilized glucose oxidase enzyme portion on an inner wall thereof for reacting with glucose in the tear fluid sample; and
a sensor comprising a working electrode including a selectivity portion for enhancing the selectivity for glucose over electroactive interferent species in the tear fluid sample, and a reference electrode disposed adjacent the working electrode;
wherein the electrochemical reaction of the enzyme portion with glucose in the tear fluid sample generates a current related to the glucose concentration in the tear fluid sample.

15. The system of claim 14, wherein the working electrode comprises a Pt/Ir wire.

16. The system of claim 14, wherein the reference electrode comprises an Ag/AgCl wire wrapped around the working electrode.

17. The system of claim 14, wherein the selectivity portion comprises coatings including NAFION® cation exchange polymer and an electropolymerized film of 1,3-diaminobenzene and resorcinol.

18. The system of claim 14, wherein the sensor is coulometric such that a total charge generated is proportional to the concentration of glucose in the tear fluid sample.

19. The system of claim 18, wherein consumption of glucose in the tear fluid sample is temperature-dependent, such that a time required for total charge detection is decreased with increased temperature.

20. The system of claim 14, wherein the sensor is capable of achieving a detection limit of about 1.5 μM of glucose in the tear fluid sample.

21. The system of claim 14, wherein a volume of the tear fluid sample required is about 3 μL or less.

22. A method for determining glucose concentration in a tear fluid sample, comprising:
providing a sensor system including a vessel for receiving a tear fluid sample, a working electrode including a selectivity portion for enhancing the selectivity for glucose over electroactive interferent species in the tear fluid sample, a reference electrode disposed adjacent the working electrode, and an immobilized glucose oxidase enzyme portion disposed on one of the working electrode and the vessel, the enzyme portion for reacting with glucose in the tear fluid sample; and
electrochemically reacting the enzyme portion with glucose in the tear fluid sample to generate a current related to the glucose concentration in the tear fluid sample.

23. The method of claim 22, wherein the working electrode comprises a Pt/Ir wire.

24. The method of claim 22, wherein the reference electrode comprises an Ag/AgCl wire wrapped around the working electrode.

25. The method of claim 22, wherein the selectivity portion comprises coatings including NAFION® cation exchange polymer and an electropolymerized film of 1,3-diaminobenzene and resorcinol.

26. The method of claim 22, wherein reacting the enzyme portion includes generating a steady-state current that is proportional to the concentration of glucose in the tear fluid sample.

27. The method of claim 22, wherein reacting the enzyme portion includes generating a total charge that is proportional to the concentration of glucose in the tear fluid sample.

28. The method of claim 27, further comprising increasing the temperature to increase the consumption of glucose in the tear fluid sample and correspondingly decrease a time required for total charge detection.

29. The method of claim 22, wherein reacting the enzyme portion includes achieving a detection limit of about 1.5 μM of glucose in the tear fluid sample.

30. The method of claim 22, wherein a volume of the tear fluid sample required is about 3 μL or less.
